(19) United States
(12) Patent Application Publication
(10) Pub. No.: US 2024/0180359 A1
(43) Pub. Date: Jun. 6, 2024

(54) METHOD FOR CLEANING AND/OR DISINFECTING AND/OR RINSING A MILK-CONDUCTING SYSTEM OF A COFFEE MACHINE, AND ASSOCIATED CLEANING DEVICE

(71) Applicant: Jura Elektroapparate AG, Niederbuchsiten (CH)

(72) Inventor: Sandro Klepzig, Teufenthal (CH)

(21) Appl. No.: 18/286,036

(22) PCT Filed: Feb. 17, 2022
(86) PCT No.: PCT/EP22/54017

§ 371 Date: Oct. 6, 2023

(30) Foreign Application Priority Data
Apr. 12, 2021 (EP) 21167852.9

(51) Int. Cl. A47J 31/60; A47J 31/44

(52) U.S. Cl. CPC A47J 31/60; A47J 31/4485; A47J 31/4496

(57) ABSTRACT

The invention relates to a method and a cleaning device for cleaning, disinfecting and rinsing a milk-conducting system of a coffee machine for producing mixed coffee beverages, in which a fluid back flow is generated at the milk outlet such that the fluid at least partly flows through the milk inlet in order to rinse the milk-conducting system.

### CROSS-REFERENCE TO RELATED APPLICATIONS

This application is a national stage of International Application No. PCT/EP2022/054017 filed on Oct. 18, 2021, which claims priority to EP Patent Application No. 2116782.9 filed Apr. 12, 2021, all of which is hereby incorporated by reference in its entirety

### FIELD OF THE INVENTION

The invention relates to a method for cleaning and/or disinfecting and/or rinsing a milk-conducting system of a coffee machine, wherein the milk-conducting system comprises a milk preparation device having a milk outlet, a fluid inlet, and an air inlet for frothing milk and a milk inlet, which are designed for conveying milk from the milk inlet to the milk outlet.

### BACKGROUND OF THE INVENTION

Methods for cleaning coffee machines are known in the prior art. A coffee machine and a method for cleaning it are known from EP 2 363 051 B2. Coffee machines and associated components are known, for example, from EP 1 656 863 A1 or EP 2 277 419 A1. In the prior art, cleaning methods are used which require a complicated switching arrangement and/or complicated switching cycles of valves and pumps and require a large number of other complex components such as Venturi nozzles.

The invention furthermore relates to a cleaning device which is suitable for cleaning a milk-conducting system of a coffee machine. Cleaning devices are known in the art and include one or more containers.

The cleaning of the milk-conducting system of a coffee machine is necessary, otherwise milk residues could remain in the coffee machine and begin to mold. This results in an annoying and unpleasant odor and the potential development of harmful organisms and thus contamination of the coffee machine.

The invention is based on the object of introducing an efficient and thorough method for cleaning a milk-conducting system of a coffee machine, which can be implemented on a large number of coffee machines and does not require any complex refitting work.

### SUMMARY OF THE INVENTION

To achieve this object, the invention proposes the features of claim 1. In particular, it is therefore proposed according to the invention in a method for cleaning and/or disinfecting and/or rinsing a milk-conducting system of a coffee machine of the type described at the outset that the method comprises a filling step in which a fluid is conveyed through the milk outlet so that an accumulation of fluid arises, as a result of which the fluid flows at least partially through the milk inlet so as to rinse the milk-conducting system. It is advantageous if the fluid is water. The accumulation can be pronounced at the milk outlet in that the outflow quantity of the fluid from the milk outlet is reduced in relation to the inflow quantity of the fluid through the fluid inlet. This can be achieved by closing the milk outlet tightly, for example via a rubber cap having a small hole or using a tightly connected cleaning device. Due to the accumulation, part of the fluid can flow through the milk inlet and the entire milk-conducting system can thus be rinsed. Thorough rinsing can thus be ensured by a simple design measure. The flow direction of the fluid can therefore furthermore be influenced, wherein a partial reversal of the flow direction of the fluid in relation to the direction of the gravitational force in an ordinary system can be achieved.

In particular, no complex switching processes of valves and/or pumps are required with the invention and the method can therefore be implemented cost-effectively and reliably. Necessary maintenance intervals of coffee machines can be extended and components of the coffee machine can remain in operation for a longer period of time before they have to be replaced or serviced. The object is achieved by the features of the independent claims. Advantageous embodiments of the invention are described in the dependent claims.

The milk-conducting system can comprise a milk preparation device having a milk outlet, a fluid inlet, a milk inlet, and an air inlet. Another part that can be included in the milk-conducting system is a milk supply line, which can connect the milk preparation device to a milk container.

In a further advantageous embodiment, it can be provided that the method includes a cleaning step, which conveys a cleaning-active and/or disinfecting substance through the milk outlet in order to clean and/or disinfect the milk-conducting system. It is advantageous if the cleaning step takes place before the filling step. The cleaning-active and/or disinfecting substance can be dissolved in water or, alternatively, can already be in the liquid state.

The conveying of fluid through the milk preparation device can be achieved by valves, pumps, and Venturi nozzles.

In a further advantageous embodiment, it can be provided that the method includes an expelling step. It is advantageous if the expelling step takes place after the filling step. The expelling step comprises supplying steam to expel the fluid through the milk inlet and through the milk outlet. It is advantageous if the supply is intermittent and discontinuous. It is advantageous if the fluid is water. It is advantageous if an accumulation is generated at the milk outlet, as described above. Thus, fluid residues can be expelled in the form of droplets and the milk-conducting system can also be dried.

In a further advantageous embodiment, it can be provided that the method includes a separating step. It is advantageous if the separating step takes place before the filling step. The separating step comprises separating a milk supply line from a milk container and then connecting the milk supply line to a mixing container so that a fluid connection can be established between the mixing container and the milk inlet. The separating step can be performed manually by a user.

In a further advantageous embodiment, it can be provided that the method includes a connecting step. It is advantageous if the connecting step takes place before the filling step. The connecting step comprises connecting the milk outlet to a collecting container, wherein the connection between the collecting container and the milk is fluidically tight. It is advantageous if pressure can be built up at the milk outlet. It is particularly advantageous if the pressure in the collecting container can be built up and the collecting container is additionally or alternatively closed.

In a further advantageous embodiment, it can be provided that the method includes an activating step. It is advantageous if the activating step takes place before the filling step. The activating step comprises supplying a fluid into the mixing container and activating the cleaning-active and/or disinfecting substance. It is advantageous if the fluid is water. The fluid can be supplied manually by a user, for example, or the fluid can flow out of an opening in the coffee machine. The cleaning-active and/or disinfecting substance can be in the form of solid granules, powder, or tablets. The cleaning-active and/or disinfecting substance can also be provided in liquid form.

In a further advantageous embodiment it can be provided that the method is carried out automatically at least after the separating step. This has the advantage that the user can occupy himself with something else and the cleaning process is carried out autonomously.

In a further advantageous embodiment, it can be provided that the accumulation arises at least partially in that an input mass flow of the fluid through the fluid inlet is limited by an output mass flow of the fluid. It is advantageous if the fluid is water or steam.

In a further advantageous embodiment, it can be provided that a compressible air cushion arises in the collecting container. The air cushion alone or in conjunction with the accumulation can cause the effect described at the outset.

In a further advantageous embodiment it can be provided that the collecting container has a drain opening through which fluid can flow into the mixing container. It is advantageous if the drain opening is circular and is additionally or alternatively matched to the milk outlet. It is advantageous if the ratio between the diameters of the drain opening and the milk outlet is at most 1:5. It is particularly advantageous if the ratio is at most 1:10.

In a further advantageous embodiment it can be provided that a liquid level in the collecting container is constant after the liquid level has at least reached the level of the drain opening.

A dynamic balance can be achieved between the mass flow that flows through the fluid inlet into the milk preparation device and the mass flows that leave the milk preparation device from the milk outlet and the milk inlet.

In order to achieve the stated object in a cleaning device, the features of the other independent claim directed to a cleaning device are provided according to the invention. In particular, in order to achieve the stated object, it is proposed according to the invention that the cleaning device comprises a collecting container which is fluidically tightly connectable to a milk outlet of a coffee machine. It is advantageous if an accumulation of fluid can form in the milk outlet. It is advantageous if a method of the above-mentioned steps can be carried out using the cleaning device.

In a further advantageous embodiment it can be provided that the collecting container has a cover. Alternatively or additionally, it can be provided that the collecting container has a drain opening, which is preferably circular and is additionally or alternatively matched to an inlet opening. It is advantageous if the inlet opening is arranged on the cover and is connectable to the milk outlet of a coffee machine, preferably in a fluidically tight manner. It is advantageous if fluid can flow into a mixing container through the drain opening. It is advantageous if the ratio between the diameters of the drain opening and the milk outlet is 1:5. It is particularly advantageous if the ratio is 1:10. The drain opening can be circular, square, or oval. It is advantageous if the drain opening is located in the upper third of the collecting container. It is particularly advantageous if the drain opening is located in the upper fourth of the collecting container. The fluidically tight connection between the milk outlet and the inlet opening on the one hand and between the cover and the collecting container on the other hand can be ensured by a sealing element which is arranged on the cover and on the inlet opening. The sealing element can consist of nitrile butadiene rubber, fluorocarbon rubber, perfluoro rubber, or similar materials.

In a further advantageous embodiment it can be provided that the cleaning device has a wall, wherein a channel is formed in the wall, which has a docking point and an outlet point, wherein the docking point can be coupled to a milk supply line. It is advantageous if this channel is cylindrical. It is advantageous if the outlet point has an opening within the or a mixing container. Thus, a fluid can easily be conducted from the mixing container to the milk supply line and vice versa.

In a further advantageous embodiment it can be provided that the collecting container has at least one water channel on the outside and additionally or alternatively a sealing element is arranged on the collecting container. It is advantageous if the sealing element consists of plastic or rubber.

Additionally or alternatively it can be provided that the mixing container and the collecting container are nested in one another and additionally or alternatively preferably integrally formed and additionally or alternatively that the cover has a closure, using which the cover and the collecting container are closable.

The water channel can be formed by a depression or indentation on the cover or by water channel delimiting elements.

The invention will now be described in more detail on the basis of several exemplary embodiments, but is not restricted to these several exemplary embodiments. Further variants of the invention and exemplary embodiments result from the combination of the features of one or more claims with one another and/or with one or more features of the exemplary embodiments and/or the above-described variants of methods and devices according to the invention.

### BRIEF DESCRIPTION OF THE DRAWINGS

In the figures:

FIG. 1 shows a milk preparation device in ordinary operation when enjoying coffee

FIG. 2 shows a milk preparation device in a perspective view

FIG. 3 shows a section through the milk preparation device from FIG. 2

FIG. 4 shows a cleaning device in a perspective view

FIG. 5 shows a cleaning device with connected milk preparation device during a cleaning, disinfecting, or rinsing method

FIG. 6 shows a vertical section along the longitudinal axis of FIG. 5

FIG. 7 shows a vertical section along the transverse axis of the cleaning device

### DETAILED DESCRIPTION

In the following description of various exemplary embodiments of the invention, elements corresponding in their function are given corresponding reference numerals even in case of differing design or formation.

A coffee machine is described using the example of a fully automatic coffee machine.

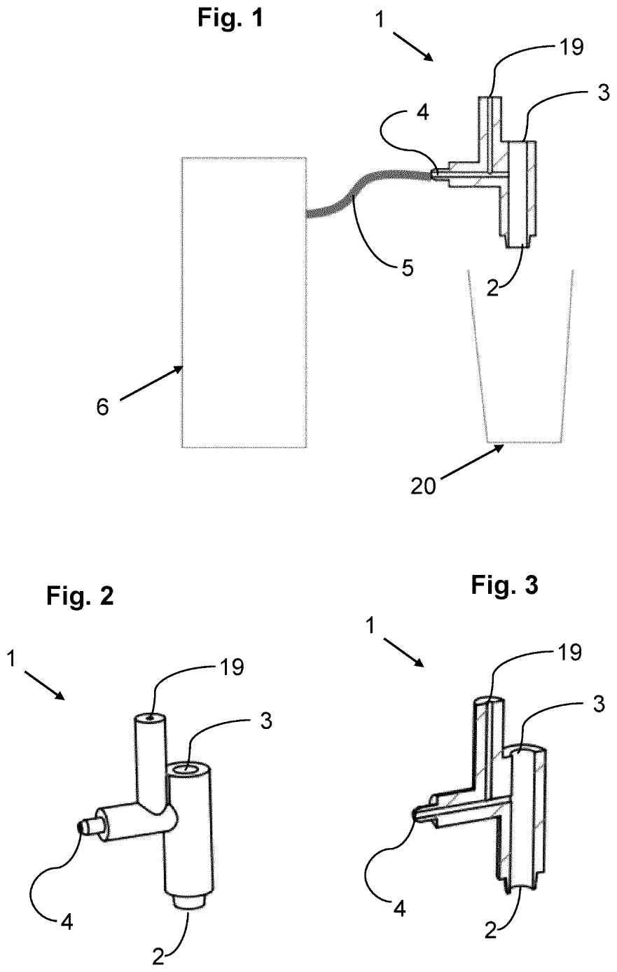

FIG. 1 shows a milk preparation device 1 in normal operation when enjoying coffee and adding milk froth and/or milk.

The milk preparation device 1 is part of the fully automatic coffee machine (not shown here) and is responsible for adding milk to a coffee drink, for example to produce a cappuccino or a Wiener Melange.

The milk preparation device 1 is vertically adjustable on the fully automatic coffee machine in order to be able to fill cups 20 of different sizes and to prevent foam or milk from splashing out of the cup.

The milk preparation device 1 comprises a milk outlet 2, a fluid inlet 3, an air inlet 19, and a milk inlet 4. The cup 20 is positioned below the milk outlet. The air inlet 19 is used to introduce air in order to froth the milk and produce a milk froth in combination with hot steam introduced through the fluid inlet.

The milk preparation device 1 is connected to a milk container 6 by a milk supply line 5, wherein the milk supply line 5 is plugged onto the milk inlet 4. The milk supply line 5 is made of rubber or plastic and is pluggable by the user onto both the milk container 6 and the milk inlet 4.

The user selects the type of coffee drink he wants and operates a user interface on the fully automatic coffee machine. In normal operation, a coffee drink, i.e., a mixture of water and coffee, is first conveyed through the fluid inlet 3 and then through the milk outlet 2 into the cup 20. The conveyance can be ensured, for example, by a switching arrangement of valves and pumps that are located in the fully automatic coffee machine.

In the next step, milk that is in the milk container 6 is conveyed through the milk supply line 5 into the milk preparation device 1 and flows through the milk outlet 2 into the cup 20, where it mixes with the coffee drink.

If necessary, air is simultaneously aspirated into the milk preparation device 1 through the air inlet 19 and mixes there with hot steam, which enters the milk preparation device 1 through the fluid inlet 3, and milk, thus producing milk froth, which can then flow into the cup 20

FIG. 2 shows a perspective view of a milk preparation device 1 which comprises a milk inlet 4, a milk outlet 2, a fluid inlet 3, and an air inlet 19. The milk preparation device 1 can be made of metal or plastic and be made of one part, or can consist of several parts which have been connected to one another. FIG. 3 shows a section through the milk preparation device 1. Numerous design options are conceivable.

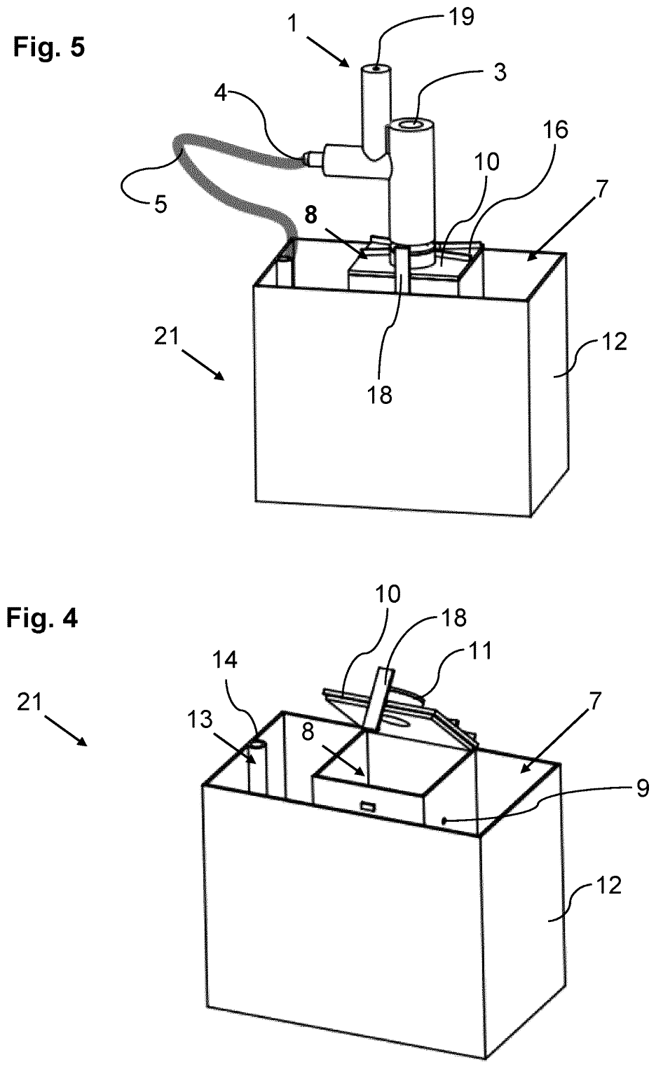

FIG. 4 shows a cleaning device according to the invention in a perspective view. The cleaning device 21 consists of a wall 12 which delimits the outside of the cleaning device 21. The cleaning device 21 also consists of a mixing container 7 and a collecting container 8, which represent two separate containers. The mixing container 7 and the collecting container 8 are nested one inside another.

The collecting container 8 has a cover 10 which has an inlet opening 11. The collecting container 8 is closable using the cover 10 by a closure 18 which is arranged on the cover 10. For this purpose there is a notch on the outside of the wall of the collecting container 8.

The collecting container 8 and the cover 10 are connectable to one another in a fluidically tight manner. The tightness is ensured by a sealing element 17 which is located on the inside of the cover 10 and on the inlet opening 11. The sealing element 17 creates a seal between the cover 10 and the collecting container 8 on the one hand and between the inlet opening 11 and the milk preparation device 1 on the other hand. The sealing element 17 can consist of nitrile butadiene rubber, fluorocarbon rubber, perfluoro rubber, or similar materials.

The cover 10 has a water channel 16 on the outside. The water channel 16 can be formed by an indentation on the cover or by water channel delimiting elements (for example as shown in FIG. 4 and FIG. 5). The water channel 16 allows water that gets on the cover to drain into the mixing container 7.

The wall of the collecting container 8 has a circular drain opening 9. The drain opening 9 allows a precisely defined quantity of liquid to flow from the collecting container 8 into the mixing container 7. The drain opening 9 is significantly smaller than the inlet opening 11 of the cover 10. The diameter of the drain opening 9 is a function of the diameter of the inlet opening 11. The ratio is advantageously at most 1:5, the ratio is particularly advantageously at most 1:10. It is advantageous if the drain opening 9 is arranged in the upper third of the collecting container 8, it is particularly advantageous if the drain opening 9 is arranged in the upper fourth of the collecting container 8.

The wall 12 has a cylindrical channel 13 which has a docking point 14 and an outlet point 15. The docking point 14 is connectable to a milk supply line 5. The outlet point 15 has an opening inside the mixing container 7.

The cleaning device 21 is advantageously made of plastic.

FIG. 5 shows a cleaning device 21 having connected milk preparation device during a cleaning, disinfecting, or rinsing method, according to this invention.

After normal operation (shown in FIG. 1) the cup 20 was removed and a cleaning device 21 was placed under the milk preparation device 1. Due to the vertical adjustability of the milk preparation device 1, the milk outlet 2 and the inlet opening 11 of the cleaning device have been fluidically tightly connected. The milk supply line 5 was unplugged from the milk container 6 and plugged onto the docking point 14 of the channel 13 of the cleaning device 21.

The milk supply line 5 is connected to the milk inlet 4 of the milk preparation device 1 and the docking point 14 of the channel 13.

A complete method for cleaning, disinfecting, and rinsing will now be described. Individual steps can take place automatically or can be omitted.

A cleaning-active and/or disinfecting substance, which can be in the form of a powder in a solid aggregate state or in a liquid aggregate state, is placed in the mixing container 7 by the user. The cleaning process is initialized by the user by an input on the fully automatic coffee machine.

Water flows out of an opening on the fully automatic coffee machine. This opening can be arranged directly above the mixing container 8 or above the collecting container 8. If the opening is arranged above the collecting container 8, the water falls onto the cover 10 and is guided into the mixing container 7 via the water channel 16, which is arranged on the cover 10.

In the mixing container 7, the water mixes with the cleaning-active and/or disinfecting substance and fills the mixing container 7 to a certain extent. The supply of water is stopped.

In the next step, the mixture of water and the cleaning-active and/or disinfecting substance is aspirated through the outlet point 15 of the channel 13 and flows through the milk supply line 5 into the milk preparation device 1, and then into the collecting container 8. As a result, the milk supply line 5 and the milk preparation device 1 are cleaned and disinfected. The collecting container 8 is continuously filled with the mixture. At this point in time, the height of the drain opening 9 has not yet been reached. After the height of the drain opening 9 has been reached and exceeded, the filling process with the mixture is ended.

In the next step, water is fed through the fluid inlet 3 into the milk preparation device 1. The fluidically tight connection of the system creates an accumulation of water. A dynamic equilibrium results between the mass flows that flow out of the milk inlet 4, out of the milk outlet 2, and out of the drain opening 9. The liquid level in the collecting container 8 levels off between the drain opening 9 and the cover 10 and is approximately constant during this step. A compressible air cushion is created between the liquid level and the milk inlet 2. Some of the water can still flow at the inner edges of the milk outlet 2 through the inlet opening 11 into the collecting container 8. Due to the accumulation, another part of the water is conveyed through the milk inlet 4 and also rinses the milk supply line 5. The accumulation occurs due to the fluidically tight connection and the flow direction of the water can thus be influenced. In an ordinary system the water would flow in the direction of gravity, in this exemplary embodiment of the invention a partial reversal takes place and part of the water can thus flow out of the milk inlet 4. This rinsing process is then ended.

In the next step, steam is fed, preferably intermittently, through the fluid inlet 3 into the milk preparation device 1, wherein part of the steam then flows out of the milk preparation device 1 through the milk outlet 2 and part of the steam through the milk inlet 4, and can thus expel any remaining droplets of fluid and at the same time dry the milk preparation device 1 and the milk supply line 5. During this step, the liquid level in the collecting container 8 drops below the level of the drain opening 9 since liquid can flow from the collecting container 8 into the mixing container 7.

In the last step, the milk preparation device 1 is pushed up vertically, wherein the fluidically tight connection between the milk outlet 2 and the inlet opening 11 on the cover 10 is disconnected. In addition, the milk supply line 5 is disconnected at the docking point 14 and then reconnected to a milk container 6.

The cleaning device 21 can then be emptied into a sink and cleaned there or in a dishwasher.

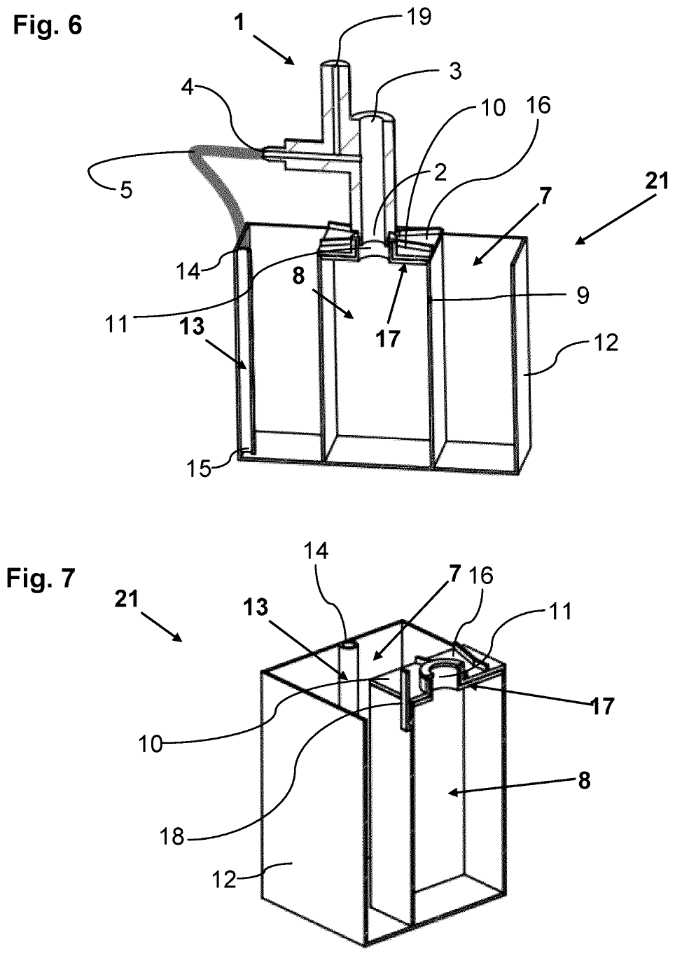

FIG. 6 shows a vertical section along the longitudinal axis of FIG. 5. The sealing element 17 is arranged along the inside of the cover 10 and at the inlet opening 11. It creates a seal between the collecting container 8 and the cover 10 and between the inlet opening 11 and the milk outlet 2.

FIG. 7 shows a vertical section along the transverse axis of the cleaning device 21.

A method and a cleaning device for cleaning, disinfecting and rinsing a milk-conducting system of a coffee machine for producing mixed coffee drinks are proposed, wherein an accumulation of fluid occurs at the milk outlet, so that the fluid flows at least partially through the milk inlet in order to rinse the milk-conducting system.

1.-15. (canceled)

16. A method for cleaning and/or disinfecting and/or rinsing a milk-conducting system of a coffee machine for producing mixed coffee drinks, wherein the milk-conducting system comprises:
a milk preparation device (1) having a milk outlet (2), a fluid inlet (3), and an air inlet (19) for frothing milk, and a milk inlet (4), which are designed for conveying milk from the milk inlet (4) to the milk outlet (2),
wherein the method comprises, in a filling step:
conveying a fluid, in particular water, through the milk outlet (2), so that an accumulation of fluid results, due to which the fluid flows at least partially through the milk inlet (4) in order to thus rinse the milk-conducting system.

17. The method as claimed in claim 16, wherein the method comprises, in a cleaning step that is prior to the filling step:
conveying a cleaning-active and/or disinfecting substance through the milk outlet (2) in order to thus clean and/or disinfect the milk-conducting system.

18. The method as claimed in claim 16, wherein the method comprises, in an expelling step that is after the filling step:
supplying intermittently steam in order to expel the fluid, in particular water, through the milk inlet (4) and through the milk outlet (2), in particular by creating an accumulation at the milk outlet.

19. The method as claimed in claim 16, wherein the method comprises, in a separating step that is prior to the filling step:
separating a milk supply line (5) from a milk container (6), in particular with subsequent connecting of the milk supply line (5) to a mixing container (7) so that a fluid connection is established between the mixing container (7) and the milk inlet (4).

20. The method as claimed in claim 16, wherein the method comprises, in a connecting step that is prior to the filling step:
connecting the milk outlet to a collecting container (8), in particular wherein pressure can be built up at the milk outlet (2), preferably in the collecting container (8), and/or in particular wherein the collecting container (8) is closed, wherein the connection between the collecting container (8) and the milk outlet (2) is fluidically sealed.

21. The method as claimed in claim 16, wherein the method comprises, in an activating step prior to the filling step:
supplying a fluid into a mixing container (7) in order to activate a cleaning-active and/or disinfecting substance.

22. The method as claimed in claim 16, wherein the method is carried out in an automated manner at least after the separating step.

23. The method as claimed in claim 16, wherein the accumulation at least partially results in that an input mass flow of the fluid through the fluid inlet (3) is limited by an output mass flow of the fluid out of the milk outlet (2).

24. The method as claimed in claim 20, wherein a compressible air cushion results in the collecting container.

25. The method as claimed in claim 20, wherein the collecting container has an outlet opening (9), which is circular and/or matched to the milk outlet (2), and through which fluid can flow into a mixing container (7).

26. The method as claimed in claim 20, wherein a liquid level in the collecting container (8) is constant after the liquid level has reached at least a height of a drain opening (9).

27. A cleaning device (21), for cleaning and/or disinfecting and/or rinsing a milk-conducting system of a coffee machine wherein the cleaning device (21) comprises a collecting container (8) having a cover (10), wherein the cover (10) has an inlet opening (11), which is connectable in a fluidically tight manner to a milk outlet (2) of a coffee machine, and in that the collecting container (8) has a drain opening (9), wherein an accumulation of fluid can be formed in the milk outlet (2).

28. The cleaning device (21) as claimed in claim 27, wherein the inlet opening (11) is connectable to the milk outlet (2) in a fluidically tight manner, and/or in that the drain opening (9), which is circular and/or matched to the or an inlet opening (11), through which a fluid can flow into a mixing container (7).

29. The cleaning device (21) as claimed in claim 27, wherein the cleaning device (21) has a wall (12), wherein a cylindrical channel (13) is formed in the wall (12), which channel has a docking point (14) and an outlet point (15), wherein the docking point (14) can be coupled with a milk supply line (5), wherein the outlet point (15) has an opening inside the or a mixing container (7).

30. The cleaning device (21) as claimed in claim 28, wherein a collecting container (8) has at least one water channel (16) on an outside and/or that a sealing element (17) is arranged on the collecting container (8), and/or in that the mixing container (7) and the collecting container (8) are nested together and/or are integrally formed, and/or in that the cover (10) has a closure (18), using which the cover (10) and the collecting container (8) are closable.
